(19) United States
(12) Patent Application Publication
(10) Pub. No.: US 2004/0080846 A1
(43) Pub. Date: Apr. 29, 2004

(54) Servo signal inspecting apparatus

(75) Inventor: Toru Nakao, Kanagawa (JP)

Correspondence Address: SUGHRUE MION,PLLC, 2100 Pennsylvania Avenue, N.W., Washington, DC, 20037-3213, US

(73) Assignee: FUJI PHOTO FILM CO., LTD.

(21) Appl. No.: 10/687,696

(22) Filed: Oct. 20, 2003

(30) Foreign Application Priority Data
Oct. 23, 2002 (JP) 2002-308398

(51) Int. Cl. G11B 27/36; G11B 21/02; G11B 5/09; G11B 5/584

(52) U.S. Cl. 360/31; 360/75; 360/53; 360/77.12

(57) ABSTRACT

A servo signal inspecting apparatus to inspect a recorded state of a servo signal with a reproducing head with a smaller width than a width of a servo track is characterized by being equipped with a magnetic tape driving unit running a magnetic tape, a reproducing head inspecting a servo signal recorded on the magnetic tape, and a head controlling unit controlling the reproducing head so as to vibrate in a range of width of the servo track in a width direction of the magnetic tape.

### FIELD OF THE INVENTION

The present invention relates to a servo signal inspecting apparatus inspecting a recorded state of a servo signal with a reproducing head.

### BACKGROUND OF THE INVENTION

These years, in a magnetic tape used for backing up data and the like of a computer, a memory capacity is increasing and some tape has equal or more than 100 GB (giga bytes) in its memory capacity. Such the magnetic tape, when forming data tracks along a longitudinal direction (running direction) of the magnetic tape, achieves their high density by increasing their number with narrowing a width of each track itself and a width between each track.

Corresponding to this, as a data recording/reproducing head in the magnetic tape, a multi-channel head providing a plurality of magnetic heads on a head unit is adopted. Then in the multi-channel head, in order to enable each magnetic head to accurately trace on each data track narrow in its width, tracking servo technology controlling a position of the head unit in a width direction of the magnetic tape is introduced.

The tracking servo technology is the technology which reads servo signals written in a magnetic tape in advance with a reproducing head and makes each magnetic tape follow each data track controlling in a width direction of the magnetic tape by driving an actuator corresponding to the read signals. In such the tracking servo technology, it is an important factor that the servo signals written as references in advance are accurately formed. Therefore, as a means to know whether or not the servo signals are accurately written, there conventionally exists an apparatus which detects defects of the servo signals with sequentially scanning several places out of whole servo signals (servo tracks) by displacing a reproducing head in a width direction of the magnetic tape every time when reciprocation movement of the magnetic tape is changed (for example, see FIG. 7 in Japan patent laid open publication 2001-266321).

However, in a conventional apparatus, if a width of a reproducing head is smaller than that of a servo track, it is not possible to detect defects in the servo track when the defects exist in portions which the reproducing head does not scan. Moreover, if minutely setting scanning places of the reproducing head to investigate a whole width of the servo track, there exists a problem that a magnetic tape needs to be reciprocated again and again and it takes time.

### SUMMARY OF THE INVENTION

An exemplary object of the present invention is to provide a servo signal inspecting apparatus which can detect defects distributing scattered in all areas of a servo track without taking time even if a width of a reproducing head is smaller than that of the servo track.

A servo signal inspecting apparatus of the invention is the apparatus to inspect a recorded state of servo signals with a reproducing head with a width smaller than that of a servo track and is characterized by being equipped with a magnetic tape driving unit running a magnetic tape, a reproducing head detecting servo signals recorded on the magnetic tape, and a head controlling unit controlling the reproducing head so as to vibrate in a range of width of the servo track in a width direction of the magnetic tape.

According to the servo signal inspecting apparatus, when it is actuated, the magnetic tape runs in one direction by the magnetic tape driving unit and the reproducing head vibrates in the range of width of the servo track by the head controlling unit. In other words, the head reads signals distributing scattered in all areas of the servo track with relatively meandering for the magnetic tape. Thus, because it is possible to read signals scattered in all areas of the servo track by only running the magnetic tape in one direction, defects can be detected without taking time if they locally exist. In addition, the apparatus enables defect detecting performance to be improved by increasing a vibration speed of the head controlling unit.

Another servo signal inspecting apparatus of the invention with the configuration of the firstly described apparatus is characterized by being provided with a plurality of reproducing heads at a predetermined interval in the magnetic tape width direction for one servo track and vibrating the plurality of reproducing heads in the range of width of the servo track all together.

According to the another servo signal inspecting apparatus, in addition to effects of the firstly described apparatus, because it is possible to minutely detect defects scattered in all areas of the servo track by vibrating the reproducing heads plurally provided for one servo track in the range of the servo track, the apparatus enables detecting accuracy of the defects to be further improved. Moreover, because amplitude of each reproducing head can be lessened by plurally providing the reproducing heads, co-displacement (displacement of a magnetic tape together with vibration of a reproducing head) of the magnetic tape can be alleviated comparing with a case of vibrating one reproducing head.

### BRIEF DESCRIPTION OF THE DRAWINGS

FIG. 1 is a plan view showing a magnetic tape on which servo signals which is an inspection objective of a servo signal inspecting apparatus related to the invention are recorded.

FIG. 2 is an enlarged plan view of a main portion showing servo signals of FIG. 1.

FIG. 3 is a configuration drawing of a servo signal inspecting apparatus related to the invention.

FIG. 4 is an enlarged plan view of a main portion showing a head unit of FIG. 3.

FIG. 5 is an enlarged plan view of a main portion showing relative movement of reproducing heads of FIG. 4 to a magnetic tape.

FIG. 6 is an enlarged plan view of a main portion showing another embodiment of the invention.

### DESCRIPTION OF THE PREFERRED EMBODIMENTS

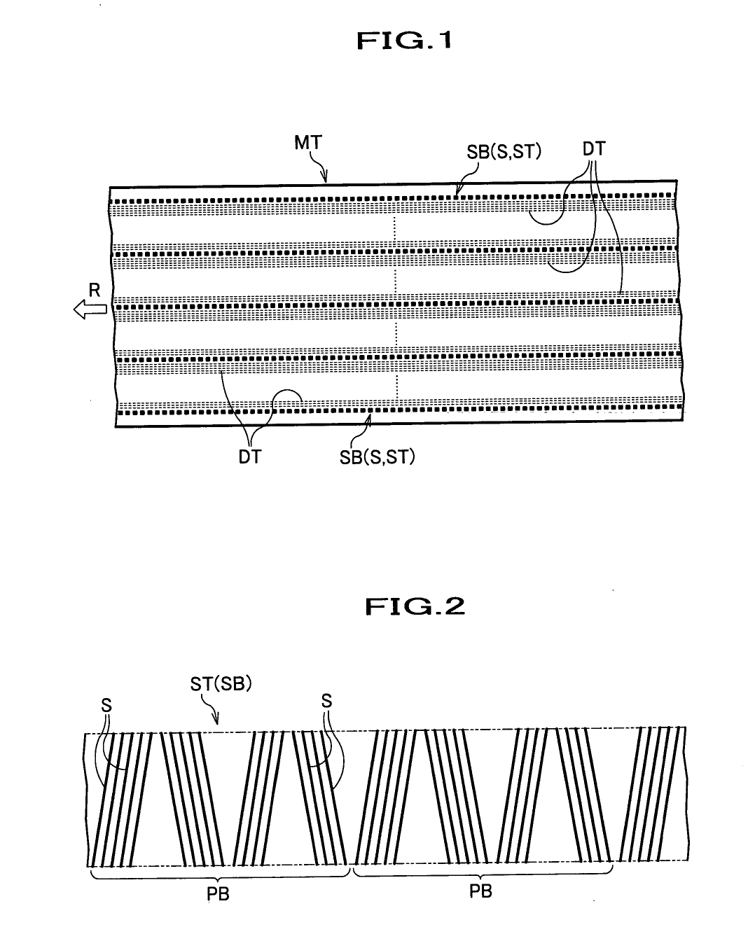

Hereinafter, a servo signal inspecting apparatus related to the present invention will be described in detail, referring to FIGS. 1 to 5 as needed.

Firstly, referring to FIGS. 1 and 2, servo signals S of an inspection objective are described.

As shown in FIG. 1, in a magnetic tape MT, five servo bands SB along a tape running direction R are arrayed in a magnetic tape width direction (hereinafter referred to as “tape width direction”) at a same interval each other and the servo signals S (hereinafter referred to as “servo tracks ST” are written by a servo writer not shown in the drawing in the five servo bands SB. Then, four bands between each servo band SB are formed in a predetermined space so that many data tracks DT can be written parallel to the servo band SB and at a predetermined pitch.

The servo signals S are a bottom-open-V-reverse-shaped pattern of timing-based servo signals and make a pattern block PB, in which a fivefold bottom-open-V-reverse-shaped pattern and fourfold bottom-open-V-reverse-shaped pattern arrayed at a predetermined pitch in the tape running direction R are combined, as a minimum unit, and the pattern block PB is repeatedly written along the tape running direction R.

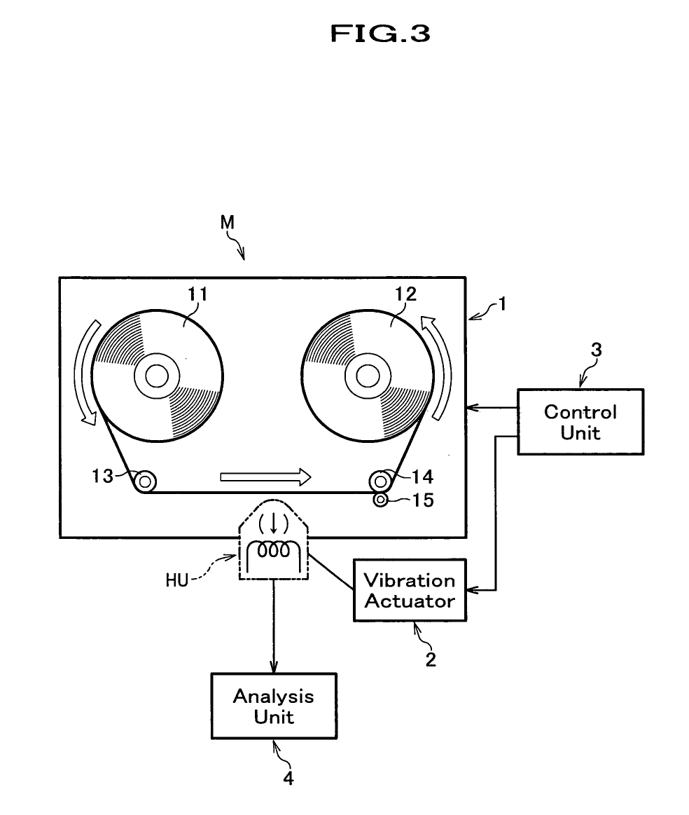

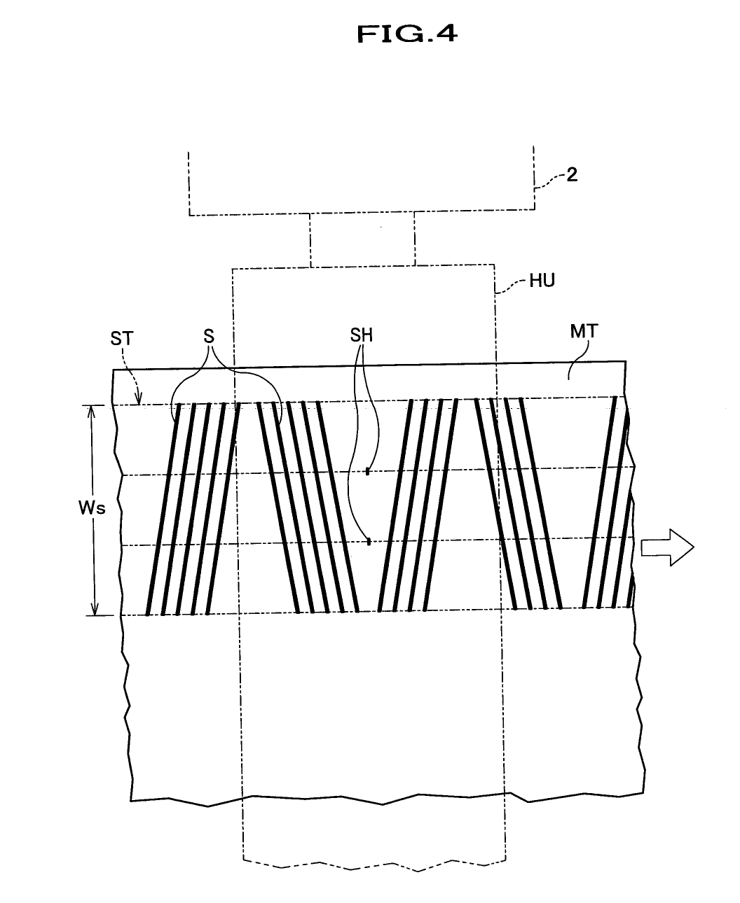

Next, referring to FIG. 3, a servo signal inspecting apparatus M is described.

As shown in FIG. 3, the servo signal inspecting apparatus M is the apparatus to inspect a recorded state of servo signals and is mainly equipped with a magnetic tape driving unit 1, a head unit HU, a vibration actuator 2, control unit 3, and an analysis unit 4. Then, with the head unit HU are connected the vibration actuator 2 and analysis unit 4, and with the control unit 3 are connected the magnetic tape driving unit 1 and vibration actuator 2.

The tape driving unit 1, which is equipped with a first reel 11, a second reel 12, a guide roller 13, a capstan roller 14, and a pinch roller 15, rotates the first and second reels in a same direction, thereby running the magnetic tape MT and reciprocating it by changing their rotation direction.

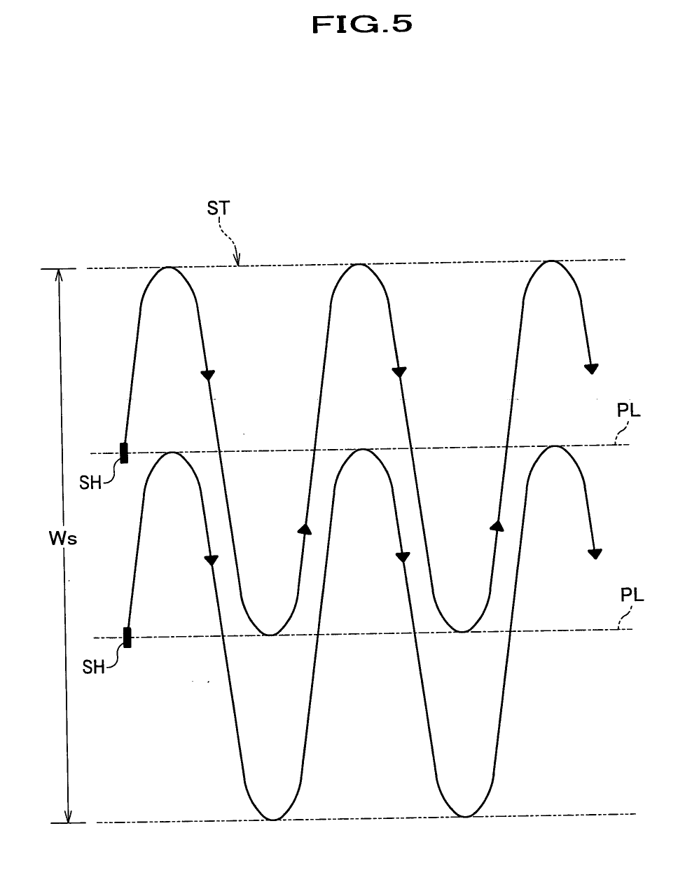

The head unit HU is, as shown in FIG. 4, set on the running magnetic tape MT and detects servo signals with two reproducing heads SH respectively provided so as to position on the five servo tracks ST (see FIG. 1) formed on the magnetic tape MT. The two reproducing heads SH are formed in a smaller width than a width Ws of the servo track ST, respectively, and provided at a predetermined interval in the tape width direction. Describing more in detail, as shown in FIG. 5, the two reproducing heads SH respectively position on two dividing lines PL which divide each one servo track ST into three. That is, one reproducing head SH positions at a place distant by one third of the width Ws from an upper end of the servo track ST and the other reproducing head SH positions at a place distant by one third of the width Ws from a lower end. In addition, reproducing heads SH provided on the other four servo tracks ST (see FIG. 1) are similarly composed as described above.

Meanwhile, although not shown in the drawings, at both sides of the tape running direction R of the head unit HU, a guide generally called an HGA (Head Guide Assembly), which regulates the magnetic tape MT in the tape width direction by a flange provided along one end edge of the tape MT and an elastic body such as a thin metal sheet provided along the other end edge, is provided. To be more precise, the guide guides the tape MT in a floated state off a guide surface by blowing air from the guide surface with which a surface of the tape MT is guided. A clearance between the flange and elastic body is, for example, set to be 0 to 1 μm. By the guide thus composed, a variation of tape width direction of the tape MT is restrained equal or less than 2 μm. Therefore, the servo signal inspecting apparatus M is designed to inspect the servo signals S in the tape width direction on the tape MT accurately positioned by the guide.

As shown in FIG. 4, the vibration actuator 2 vibrates the two reproducing heads all together in the range of width Ws of the servo track ST in the tape width direction. To be more precise, the vibration actuator 2 makes, as shown in FIG. 5, each reproducing head SH vibrate in amplitude of one third of width Ws of the servo track ST.

As shown in FIG. 3, the control unit 3 controls a rotation speed and change of rotation direction of each reel 11 and 12 of the magnetic tape driving unit 1, and controls a change of vibration speed of the vibration actuator 2.

Meanwhile, a “head control unit” described in claims of the invention is composed of the vibration actuator 2 and control unit 3.

The analysis unit 4 is the unit to analyze whether or not there exist defects in the servo signals S based on signals read with the two reproducing heads SH. To be more precise, as the analysis unit 4, for example, a unit in which data obtained in inspecting normally recorded servo signals S with the servo signal inspecting apparatus M is made to be memorized as standard data in advance, and which finds defects of the servo signals S by comparing the standard data with data in inspection, can be thought of.

Next, operation of the servo signal inspecting apparatus M is described. As shown in FIG. 3, when actuating the inspecting apparatus M, the magnetic tape MT runs in one direction by the magnetic tape driving unit 1 and the two reproducing heads SH vibrates as shown in FIG. 5 in the range of width Ws of the servo track ST by the vibration actuator 2. In other words, relatively meandering for the tape MT, the reproducing heads SH result in reading signals distributing scattered in all areas of the servo track ST. Then, the signals read with the reproducing heads SH are sent to the analysis unit 4, and detected values with the reproducing heads SH and the standard data memorized in advance are compared by the analysis unit 4, whereby the inspection result is displayed on a display unit not shown in the drawings and the inspection of the servo signals terminates.

Thus, the embodiment can obtain following effects:

1. Because it is possible to read signals scattered in all areas of the servo track ST by only running the magnetic tape MT in one direction, even in the case that defects locally exist on the servo track ST, they can be detected without taking time; and

2. Because the servo track ST is minutely traced with the reproducing heads SH in case of increasing a vibration speed of the vibration actuator 2, the servo signal inspecting apparatus M enables defect detecting performance to be improved.

Meanwhile, the present invention is not limited to the embodiment and is practiced in various forms.

I. In the embodiment, although the servo signal inspecting apparatus M is described as a simple body, the invention is not limited to this: building composing components such as the servo signal inspecting apparatus M in a servo writer and magnetic tape drive, it may be available to inspect servo signals after/before servo data is recorded.

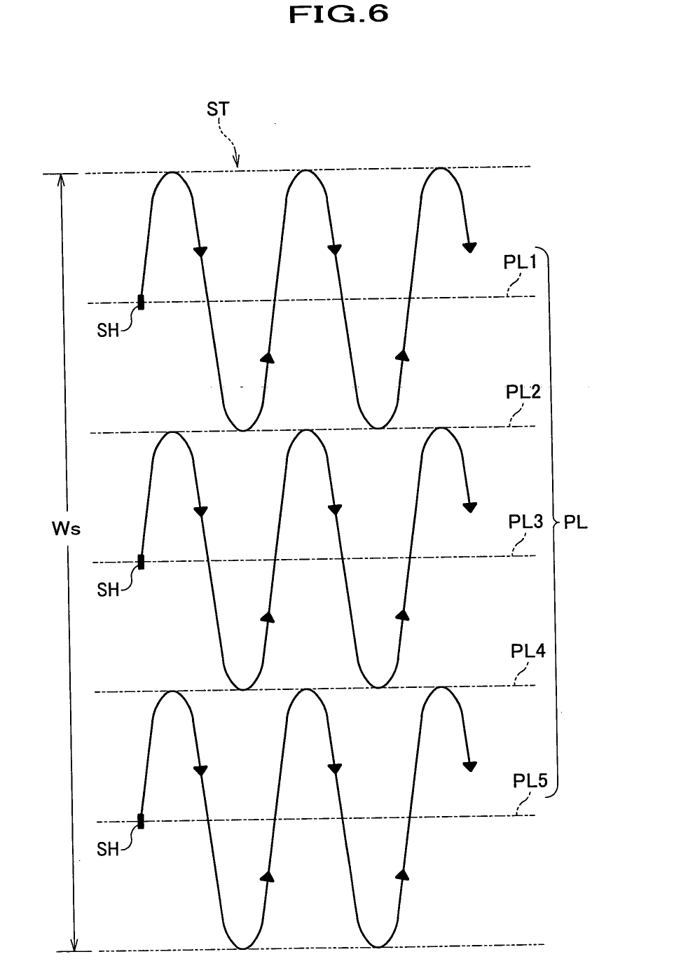

II. In the embodiment, although the two reproducing heads SH is provided, the invention is not limited to this and a number of reproducing heads may be one and more than two: for example, when providing three reproducing heads, as shown in FIG. 6, out of dividing lines PL in dividing the width Ws of the servo track ST into six, it suffices to respectively provide reproducing heads on a dividing line PL1 positioning uppermost, a dividing line PL3 positioning middle, and a dividing line PL5 positioning lowest and to vibrate them; that is, it suffices to provide the reproducing heads on positions respectively distant from upper/lower ends of the servo track ST by one sixth of the width Ws and on the middle position of the servo track ST, and to respectively vibrate them at amplitude of one sixth of the width Ws.

III. In the embodiment, although one pair of reproducing heads SH are respectively provided for the five servo tracks ST, the invention is not limited to this: for example, the five servo tracks ST may be inspected by the vibration actuator 2 moving the pair of reproducing heads SH to a position of each servo track ST as needed.

What is claimed is:

1. A servo signal inspecting apparatus to inspect a recorded state of a servo signal with a reproducing head with a smaller width than a width of a servo track, the apparatus comprising:
a magnetic tape driving unit running a magnetic tape;
a reproducing head inspecting a servo signal recorded on said magnetic tape; and
a head controlling unit controlling said reproducing head so as to vibrate in a range of width of said servo track in a width direction of said magnetic tape.

2. A servo signal inspecting apparatus according to claim 1, wherein a plurality of said reproducing heads are provided at a predetermined interval for one said servo track; and
wherein said plurality of reproducing heads are made to vibrate all together in a range of width of said servo track by said head controlling unit.

3. A servo signal inspecting apparatus according to claim 1, which comprises a head guide assembly guiding a magnetic tape in a floated state off a guide surface by blowing air from said guide surface with which a surface of said magnetic tape is guided.

4. A servo signal inspecting apparatus according to claim 2, which comprises a head guide assembly guiding a magnetic tape in a floated state off a guide surface by blowing air from said guide surface with which a surface of said magnetic tape is guided.

5. A servo signal inspecting system comprising:
a servo signal inspecting apparatus according to claim 1; and
an analysis unit analyzing whether or not defects exist in servo signals based on signals read with a reproducing head.

6. A servo signal inspecting system comprising:
a servo signal inspecting apparatus according to claim 2; and
an analysis unit analyzing whether or not defects exist in servo signals based on signals read with a reproducing head.

7. A servo signal inspecting system comprising:
a servo signal inspecting apparatus according to claim 3; and
an analysis unit analyzing whether or not defects exist in servo signals based on signals read with a reproducing head.

8. A servo signal inspecting system comprising:
a servo signal inspecting apparatus according to claim 4; and
an analysis unit analyzing whether or not defects exist in servo signals based on signals read with a reproducing head.

9. A servo signal inspecting system according to claim 5, wherein said analysis unit memorizes data obtained from normally recorded servo signals as standard data in advance and compares the standard data with data in inspection, thereby finding defects of servo signals.

10. A servo signal inspecting system according to claim 6, wherein said analysis unit memorizes data obtained from normally recorded servo signals as standard data in advance and compares the standard data with data in inspection, thereby finding defects of servo signals.

11. A servo signal inspecting system according to claim 7, wherein said analysis unit memorizes data obtained from normally recorded servo signals as standard data in advance and compares the standard data with data in inspection, thereby finding defects of servo signals.

12. A servo signal inspecting system according to claim 8, wherein said analysis unit memorizes data obtained from normally recorded servo signals as standard data in advance and compares the standard data with data in inspection, thereby finding defects of servo signals.

13. A servo signal inspecting method to inspect a recorded state of servo signals with a reproducing head with a smaller width than a width of a servo track, the method comprising the steps of:
running a magnetic tape and vibrating said reproducing head in a range of width of said servo track in a width direction of said magnetic tape, and inspecting servo signals recorded on said magnetic tape.

14. A servo signal inspecting method according to claim 13, which comprises an analyzing step to analyze whether or not defects exist in servo signals based on signals read with said reproducing head.

15. A servo signal inspecting method according to claim 13, the method comprising the steps of:
a standard data recording step memorizing data obtained from normally recorded servo signals as standard data in advance; and
a comparing step comparing the standard data with data in inspection.
